(19) United States
(12) Patent Application Publication
(10) Pub. No.: US 2006/0289473 A1
(43) Pub. Date: Dec. 28, 2006

(54) Heating assembly with track-like electrical resistor

(75) Inventor: Simon Kaastra, Dinxperio (NL)

Correspondence Address: THE WEBB LAW FIRM, P.C., 700 KOPPERS BUILDING, 436 SEVENTH AVENUE, PITTSBURGH, PA, 15219, US

(73) Assignee: FERRO TECHNIEK HOLDING B.V., Gaanderen (NL)

(21) Appl. No.: 10/549,866

(22) PCT Filed: Mar. 23, 2004
(86) PCT No.: PCT/NL04/00198

§ 371 Date: Aug. 8, 2006

(30) Foreign Application Priority Data
Mar. 25, 2003 (NL) 1023011

(51) Int. Cl. H05B 3/06

(52) U.S. Cl. 219/542; 219/552

(57) ABSTRACT

The invention relates to a heating assembly, comprising: a carrier provided with at least one track-like electrical resistor arranged on one side of the carrier, and a support member engaging on the carrier on the side of the track-like electrical resistor, wherein the carrier is flexible and the support member is at least substantially form-retaining.

The invention relates to a heating assembly with a carrier provided with at least one track-like electrical resistor arranged on one side of the carrier.

Such heating assemblies are used on a large scale in for instance domestic appliances, and industrial and commercial heating appliances. By carrying a sufficiently large electric current through the track-like electrical resistor the resistor heats up, which heat is then partially passed on to the carrier. A product for heating (for instance—but not only—a medium) is usually situated on the side of the carrier remote from the track-like electrical resistor. The product for heating is thus separated from the electrical resistor, and no undesired interaction between the two can occur. A known example hereof is the bottom of a commercially available water boiler. Another example is described in the American patent U.S. Pat. No. 6,353,707. Here an electrical heating device is disclosed with a flexible resistor ribbon consisting of metal foil. A plurality of segments of an electrically conducting coating are arranged on the resistor ribbon at preset intervals. In a specific embodiment of this invention, the resistor ribbon is arranged on a flat carrier, wherein the flat carrier is a plastic or ceramic tile. In another specific embodiment of this invention, the resistor ribbon is arranged between a carrier and a plate connected to the carrier parallel thereto, wherein the resistor ribbon is enclosed between the carrier and an electrically insulating layer to be arranged thereon.

The drawback of the prior art heaters is that requirements are laid down for the carrier of the electrical resistor in respect of the mechanical load-bearing capacity and form-retention whereby the carrier must have a considerable thickness, which results in limitations both in use and during manufacture.

The object of the present invention is to provide a heating assembly of the type stated in the preamble wherein fewer of the limitations existing heretofore are imposed on the choice of a carrier.

The invention provides for this purpose a heating assembly, comprising: a carrier provided with at least one track-like electrical resistor arranged on one side of the carrier, and a support member engaging on the carrier on the side of the track-like electrical resistor, wherein the carrier is flexible and the support member is at least substantially form-retaining. In such an assembly the dimension (in particular the thickness) and the choice of material for the carrier are not determined, or determined to a lesser degree than before, by the mechanical load-bearing capacity of the carrier. The strength of the heating assembly will after all be substantially derived from the support member. This results in a number of distinct advantages. The freedom of choice in respect of the thickness of the carrier makes it possible to embody the carrier thinner than according to the prior art; with a thinner carrier the response time of the heating assembly (during both heating and feedback) is shortened relative to the prior art, as a thinner carrier means a smaller heat capacity of the carrier. A thinner carrier with attached track-like electrical resistor also results in a reduced tension in the carrier and in the connection of the carrier to the track-like electrical resistor. Another significant advantage of a thinner carrier is that it is more easily deformable than a thicker carrier, which makes it possible to give the carrier more complex forms with relatively limited effort. Yet another advantage is that the carrier can be made flexible such that it becomes possible, after contamination of the carrier (for instance by limescale from water for heating), to deform the carrier temporarily whereby harder contaminants come loose from the carrier. It should moreover be noted that the material properties of the carrier must be such that they can withstand the effect of the products for heating (for instance a requirement in respect of corrosion resistance), while this need not be the case for the support member. The support member can hereby be optimized with less stringent requirements, which will in practice result in a cost price reduction of the support member compared to the cost price of a prior art carrier which must comply with more stringent requirements in respect of the material quality.

In a preferred variant the carrier is plate-like, thereby providing a plate-like heating surface as is in widespread use in practice. The track-like electrical resistor can be formed in economic manner by means of a thick film layer.

As alternative to a flat carrier, the carrier can also be provided with raised and lowered parts. This becomes an all the more feasible option now that the carrier can be deformed relatively easily. It even becomes possible here for the carrier to be formed by two carrier parts which are placed against each other and between which there is defined a passage for a medium for heating. The great freedom in the design of the carrier parts makes it possible to create a medium passage between carrier parts of a limited cross-section. This results in the flow rate of the medium through such a passage being relatively high, which can be usefully employed to prevent, or at least limit, contamination of the carrier parts. A higher flow rate will result in reduced deposition of contaminants, the speed required for this purpose also being determined by other process conditions (medium, degree of contamination of medium, carrier material, temperature, pressure and so on).

Depending on the choice of material for the carrier, the track-like electrical resistor can be connected to the carrier via an insulating layer; this is particularly desirable when the carrier is manufactured from an electrically conductive material (such as the metal carriers often applied).

In order to prevent an electrically conducting contact between the support member and the track-like electrical resistor, the support member can be manufactured from an electrically insulating material, such as for instance plastic or ceramic. Another solution for preventing an electrically conducting contact between the support member and the track-like electrical resistor is to design the support member such that it only engages on the carrier at positions where the latter is not provided with the track-like electrical resistor. In a subsequent variant the support member engages on the track-like electrical resistor via an electrically insulating material. The support member can be provide with any desired shape, in a simple variant the support member is plate-like.

The present invention will be further elucidated with reference to the non-limitative exemplary embodiments shown in the following figures. Herein:

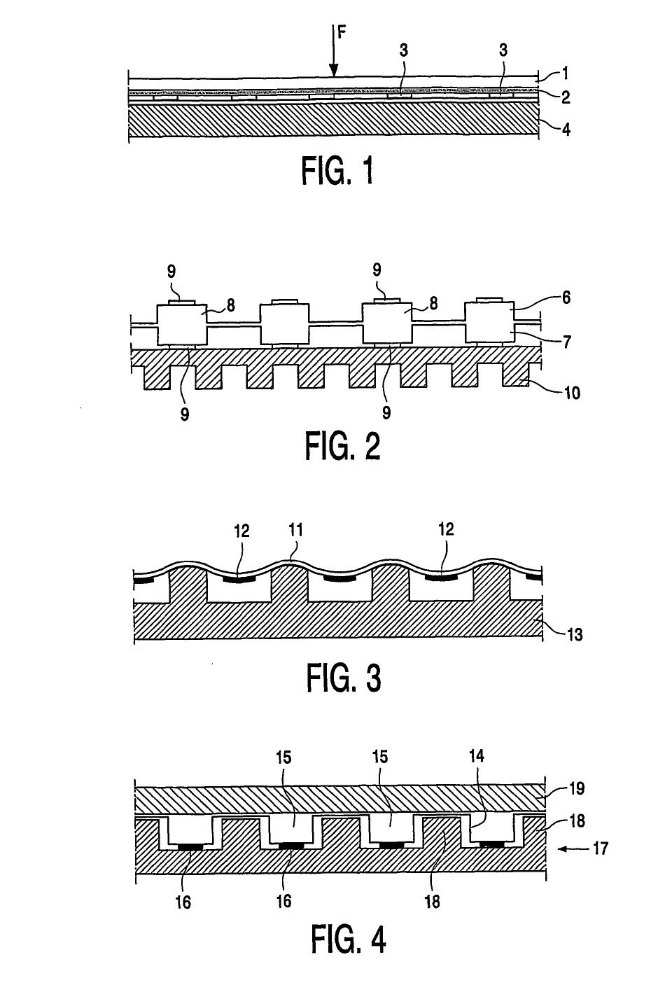

FIG. 1 shows a cross-section through an embodiment variant of a heating assembly according to the present invention,

FIG. 2 shows a cross-section through a second embodiment variant of a heating assembly according to the present invention,

FIG. 3 shows a cross-section through a third embodiment variant of a heating assembly according to the present invention, and

FIG. 4 shows a cross-section through a fourth embodiment variant of a heating assembly according to the present invention.

FIG. 1 shows a metal carrier 1 on which an electrically insulating layer 2 (of for instance enamel or plastic) is arranged. Electrically conducting tracks 3 are arranged on the electrically insulating layer 2 by means of thick film technology. Metal carrier 1, electrically insulating layer 2 and electrically conducting tracks 3 are connected fixedly to each other. Since carrier 1 has a relatively limited thickness, it will not be rigid. So as to nevertheless be able to withstand sufficient load according to the arrow F, carrier 1 is supported by a support plate 4 on which an insulating layer (for instance of enamel or plastic) is arranged on the side directed toward tracks 3. Support plate 4 is herein dimensioned such that it is sufficiently rigid to absorb the load according to arrow F without substantial deformation of support plate 4. Support plate 4 can be manufactured from a material of choice, although it is self-evident to select a metal for the purpose.

FIG. 2 shows a carrier assembled from two carrier parts 6, 7. Carrier parts 6, 7 are formed such that between carrier parts 6, 7 there are created channels 8 through which a medium for heating (not shown) can be carried. Since few demands are made of carrier parts 6, 7 in respect of rigidity, carrier parts 6, 7 can be readily brought into the desired shape. Arranged on carrier parts 6, 7 at the position of channels 8 are electrically conducting tracks 9 with which the desired heat can be generated. A support member 10 engages directly onto the tracks 9 and must therefore be manufactured from an electrically insulating material such as for instance plastic.

FIG. 3 shows an undulating carrier 11 on which electrically conducting tracks 12 are arranged. A support member 13 engages on carrier 11 such that it is not in contact with tracks 12. Support member 13 does not hereby have to meet any requirements in respect of electrical insulation, which can result in a further reduction in cost price.

FIG. 4 shows a carrier 14 in which channels 15 are arranged. Electrical heating tracks 16 are arranged on the side of carrier 14 remote from channels 15. Carrier 14 is enclosed between a support member 17, provided with protrusions 18, and a cover plate 19 such that channels 15 remain clear for passage of a medium. Protrusions 18 of support member 17 also contribute toward a good (preferably, but not necessarily, medium-tight) connection of carrier 14 to cover plate 19.

1-10. (canceled)

11. A heating assembly, comprising:
a carrier with a heating surface,
at least one heating element arranged on the carrier on the side opposite to the heating surface, and
an at least substantially form-retaining support member engaging on the carrier on the side opposite to the heating surface,
wherein
the heating element is a track-like electrical resistor, and the carrier is flexible.

12. The heating assembly as claimed in claim 11, wherein the carrier is plate-like.

13. The heating assembly as claimed in claim 11, wherein the track-like electrical resistor is formed by a thick film layer.

14. The heating assembly as claimed in claim 11, wherein the carrier is provided with raised and lowered parts.

15. The heating assembly as claimed in claim 11, wherein the carrier is formed by two carrier parts which are placed against each other and between which there is defined a passage for a medium for heating.

16. The heating assembly as claimed in claim 11, wherein the track-like electrical resistor is connected to the carrier via an insulating layer.

17. The heating assembly as claimed in claim 1, wherein the support member is manufactured from an electrically insulating material.

18. The heating assembly as claimed in claim 11, wherein the support member is designed such that it only engages on the carrier at positions where this latter is not provided with the track-like electrical resistor.

19. The heating assembly as claimed in claim 11, wherein the support member engages on the track-like electrical resistor via an electrically insulating material.

20. The heating assembly as claimed in claim 11, wherein the support member is plate-like.
